(19) United States
(12) Patent Application Publication
(10) Pub. No.: US 2004/0131743 A1
(43) Pub. Date: Jul. 8, 2004

(54) Quickly dissolving aerated confections and methods of preparation

(76) Inventors: Diran Ajao, St. Paul, MN (US); James W. Geoffrion, Anoka, MN (US); Jay D. Lange, Andover, MN (US); Steven J. Leusner, Sudbury, MA (US); Bernhard H. Van Lengerich, Plymouth, MN (US); Philip K. Zietlow, Wayzata, MN (US)

Correspondence Address: GENERAL MILLS, INC., P.O. BOX 1113, MINNEAPOLIS, MN, 55440, US

(21) Appl. No.: 10/337,030

(22) Filed: Jan. 6, 2003

(51) Int. Cl. A23L 1/00

(52) U.S. Cl. 426/564

(57) ABSTRACT

Aerated confections that dissolve quickly in water or in cold milk are disclosed. The aerated food products preferably include 50 to 98% of a saccharide component; about 0.5 to 30% of a structuring agent; about 1 to 6% moisture; and about 1% to 5% of a non-proteinaceous whipping agent. The aerated food products have a density of about 0.1 to 1.0 g/cc. The compositions can be formed into pieces ranging from about 0.1 to 5 g each. Preparation methods for the pieces are also disclosed. The confectionery food products find particular suitability for use as ingredients for children's RTE cereals.

### BACKGROUND OF THE INVENTION

The present invention is directed generally to food products and to their methods of preparation. In particular, the present invention is directed to improved aerated confectionery products such as dried marshmallows that dissolve quickly in cold water or milk and to processes for making such quick dissolving aerated, confectionery products.

Aerated confections products are popular food items. Some products are fabricated from aerated confection compositions that comprise a fat constituent while others are substantially free of such fat constituents. An illustrative fat free aerated confection is the common marshmallow. Such marshmallow products are familiar in both larger and smaller sizes.

It is well known that such marshmallows when fresh are soft and pliable but will stale by losing moisture and become hard. Indeed, purposefully pre-dried aerated confections are also well known. These products, particularly in smaller or bite sizes, are commonly added to certain popular Ready-To-Eat (“RTE”) breakfast cereals, particularly those marketed to children. Due to their small size (i.e., having a number count of 4 to 6/g), these dried aerated confectionery marshmallow products are sometimes colloquially referred to as “Mar.” bits or “marbits”. The marbits must be pre-dried prior to admixture with the RTE cereal in order to reduce unwanted moisture migration from the marbit to the cereal and thus to forestall the multiple problems resulting therefrom. These dried marshmallow pieces exhibit desirable crisp, frangible eating qualities.

While there are many types of marshmallow products on the market, their methods of preparation generally fall into two main process groups: extruded marshmallow and deposited marshmallow. In both types, a sugar syrup, a structuring agent, and a whipping agent are the main ingredients. Often, gelatin is used as both the whipping agent to form an aerated foam as well as the structuring agent for setting the foam. Typically, the sugar syrup is heated to reduce moisture and is thereafter cooled down, and then combined with the gelatin solution to form a slurry. That slurry is then aerated to form a foam, and after aeration, colors and flavors are then added to the foam. The particular marshmallow product may be formed into its final shape by an extrusion process. That is, after aeration, the foam is extruded through a die to form a rope. The die imparts the desired peripheral shape to the extrudate rope. The rope is allowed to rest briefly to set, and then is cut into desired sizes. For dried marshmallows, the process can additionally include one or more drying steps. (See, for example U.S. Pat. No. 4,785,551 issued 2 Nov. 1988 to W. J. Meyer entitled “Method of Drying Confection Pieces” which is incorporated herein by reference).

While marshmallows of a single color are most common, marshmallows having two or even a plurality of colors (collectively herein, “multi-colored”) are also known (see, for example, D 376,039 issued Dec. 3, 1996 entitled “Food Product”, incorporated herein by reference, showing a two color marbit design) as well as methods for their preparation. (See, for example, U.S. Pat. No. 4,925,380 issued Oct. 20, 1986 entitled “Multicolor Confection Extrusion System and U.S. Pat. No. 5,019,404 issued Feb. 28, 1990 entitled “Multicolor Confection Extrusion System”, each of which are incorporated herein by reference). Both the '404 and '380 well describe the difficulties and sensitivities of such foam product preparation. The conventional processes for making multi-colored marshmallows teach to divide the aerated foam into a plurality of sub-streams, to admix a desired colorant to each sub-stream, and then extrude these colored sub-streams in substantially equal portions into a single rope or multiplicity of such ropes.

While multicolored marshmallow pieces have enhanced consumer appeal particularly for children's products, there is a continuing need for new confection products having novel appearance and appeal.

Generally, dried marshmallow pieces soften but do not dissolve upon exposure to cold milk and rapidly loose their desirable crisp and frangible eating qualities. Efforts have been thus been made at extending the bowl life of dried marshmallow pieces in cold milk, i.e., to lessen their propensity to soften in cold milk. Thus, previously, dried marshmallow piece that remained crisp in milk for times exceeding three minutes were considered to be desirable.

Dried marshmallows comprising a slowly dissolving portion and a more quickly dissolving portion have recently been developed. (See for example, U.S. Pat. No. 6,207,216 “Quickly dissolving Aerated Confection and Method of Preparation issue Mar. 27, 2001 to Zietlow et al. and U.S. Pat. No. 6,436,455 “Multi-Colored Aerated Confectionery Products” issued Aug. 20, 2002 to Zietlow et al., each of which is incorporated herein by reference). Such products appeal to children by having a portion more quickly dissolve in cold milk to reveal thereby a shape in relief. These products generally comprise quickly dissolving confection formulations that comprise sugar(s), a protein whipping agent that forms a foam, and a structuring agent such as gelatin that structures the foam after drying. While gelatin alone functions as the aerating agent for slow to dissolve dried marshmallow confections, the addition of the protein based whipping agent in partial substitution for conventional gelatin provides such quickly dissolving dried confections. Such whipping agents are generally a protein based whipping agent, generally a modified soy protein whipping agent or less frequently various milk derived ingredients.

However, many consumers exhibit sensitivity or allergic reactions to one or more of such protein based whipping agents. Thus, it would be desirable to be able to formulate dried aerated confections and in particular quickly dissolving dried aerated confections that do not require allergenic protein based whipping/foaming ingredients to mitigate the potential for food allergic reactions to such ingredients.

Surprisingly, the above needs can be met and improved hypoallergenic aerated confections, including quickly dissolving aerated confections are provided that they do not require protein based foaming. The present improved aerated confections comprise selected non proteinaceous foaming agents in substitution for the protein based whipping agents of the '216 patent in addition to sugars and a structuring agent.

The present invention additionally provides methods of preparing such improved quickly dissolving dried aerated confections. In variations, composite dried confections are prepared comprising a portion of the present improved hypoallergenic quickly dissolving dried confection compositions and a slowly dissolving confection portion.

The present invention also provides method of preparing such composite dried confections by substituting the present marshmallow compositions for those of the '216 patent's methods.

### BRIEF SUMMARY OF THE INVENTION

In its product aspect, the present invention resides in dried aerated confections compositions and products prepared there from that dissolve quickly in cold water or milk.

The quickly dissolving aerated confections compositions comprise:

About 50 to 95% of a saccharide component;

About 0.5 to 30% of a structuring agent; and,

About 1% to 5% of a non proteinaceous whipping agent.

About 1 to 6% moisture; (Final moisture)

The balance of the composition can be supplied by various conventional optional ingredients.

The confection compositions have densities of 0.10 to 1 g/cc.

The products are additionally characterized by a size count of 0.2 to 6/g and having moisture content of 1 to 6%. These products can have a body of one color or the body can comprise a plurality of disparately colored phases.

In its principle method aspect, the present invention provides methods of preparing such quickly dissolving aerated confections compositions. The composition methods of preparation comprise the steps of:

A. preparing a slurry comprising

about 80% to 85% nutritive carbohydrate sweetening component,

about 2%-6% of a marshmallow structuring component,

about 0.1% to about 1% of a non proteinaceous foaming agent, and the balance of moisture

comprising the substeps of:

1. admixing at least a portion of the nutritive carbohydrate component in dry form with the non proteinaceous foaming agent to form a dry blend;

2. admixing the dry blend in at least a major portion of water to form a syrup and hydrate the foaming agent

3. admixing the balance of the nutritive carbohydrate sweetening component to the syrup;

4. heating the syrup to dissolve the sweeteners to about 75-100° C. (about 170-212° F.) to form a hot clear sugar syrup;

5. hydrating the structuring agent in the balance of the moisture to form a hydrated structuring agent;

6. cooling the hot clear sugar syrup to a temperature of 72° C. or cooler to form a cooled clear sugar syrup;

7. admixing the hydrated structuring agent with the cooled sugar syrup to form a slurry;

B. Aerating the slurry with nitrogen to form a hot plastic aerated marshmallow foam having a moisture content of about 10% to about 15%;

C. Forming the foam into pieces; and,

D. Drying the pieces to a moisture content of 1-6% to form quickly dissolving dried marshmallow pieces.

In another method aspect, the present invention provides methods for preparing a composite products comprising a first portion quickly dissolving aerated confections, and a second portion of a slowly dissolving aerated confection comprising the steps of:

A. providing a first steam of first aerated confection composition having one portion fabricated from a quickly dissolving aerated confection composition having:

a moisture content of about 8% to about 25%;

a density of about 0.1 to about 1.0 g/cc;

a temperature of about 70 to 180° F.; and,

B. providing a second steam of a second aerated confection composition fabricated from a slowly dissolving aerated confection composition having:

a moisture content of about 8% to about 25%;

a density of about 0.1 to about 1.0 g/cc;

a temperature of about 49 to 83° C. (120° F. to 180° F.); and,

C. coextruding the first steam and second steam under pressure in an extruder without substantial intermingling of the extrusion steam to form a combined steam;

D. severing the combined steam into pieces;

E. drying the aerated confection pieces to a moisture content of about 1% to 6 to form dried aerated confections having a first quickly dissolving portion and that dissolve in second slowly dissolving portion.

### BRIEF DESCRIPTION OF THE DRAWINGS

FIG. 1 is a perspective view of an aerated confection product of the present invention comprising a quick dissolving portion aerated and a slowly dissolving portion.

### DETAILED DESCRIPTION OF THE INVENTION

The present invention provides improved hypoallergenic dried aerated confections compositions and products prepared therefrom that dissolve quickly in cold water or milk and to methods for preparing aerated confections products. Each of the product ingredients and product features and steps of the present methods are described in detail below.

Throughout the specification and claims, percentages are by weight and temperatures in degrees Centigrade unless otherwise indicated.

The present invention provides improved aerated confectionery products that comprise a quickly dissolving but not “instantly” dissolving aerated confection. These confectionery products find particular suitability for use as added components to children's ready-to-eat breakfast cereals. Thus, by “quickly dissolving” herein is meant that a 0.2 g piece (whether spherical, cylindrical, or cube shaped) dissolves in liquid water or in a dairy beverage such as cold milk at a temperature above freezing up to 65° C. in about 10 to under 120 seconds. Better products dissolve in cold milk (5° C.) in about 20 to 90 seconds. If the confectionery product dissolves too quickly (i.e., in 5 to less than 10 seconds), then the product is “instantly dissolvable”. If the confectionery product dissolves more slowly, (i.e., in about greater than 120 seconds), then the product is “slowly dissolvable”. Slowly dissolvable products include conventional dried aerated marshmallow compositions that become soft upon extended exposure to cold milk (e.g., over 120 seconds) and dissolve thereafter only very slowly. Both instantly dissolvable and slowly dissolvable are unsuitable for use herein as the principal essential product component although each component can be used alone or together as an optional additional component or portion.

By “aerated confection product” is meant an aerated solid confectionery food product in solid form having a density in the range of from about 0.10 to about 1 g/cc.

The improved quickly dissolving aerated confectionery compositions essentially comprise 1) saccharides, 2) a non proteinaceous foaming component(s), 3) a structuring component, and 4) residual moisture.

The improved quickly dissolving aerated confectionery composition products are fabricated from compositions that essentially comprise about 50 to about 95% of a saccharide component as the principle ingredient preferably about 65 to 95%. Most preferably, the saccharide component is used at about 80% to 85% of the confectionery compositions.

The saccharide component can include nutritive carbohydrate sweetening ingredients such as pure monosaccharide dextrose (e.g., anhydrous, monohydrate or dextrose syrup) and disaccharide sugars such as sucrose, and fructose, as well as hydrolyzed starch syrups such as corn syrup which include dextrin, maltose and dextrose, invert sugar syrups which include levulose and dextrose and/or converted fructose or glucose syrups. In preferred variations, the saccharides are provided by such nutritive carbohydrate sweetening ingredients or pure sugars. In other variations, all or a portion of the saccharide component can be supplied by impure or flavored saccharidic ingredients such as fruit juices, purees, honey nectars, concentrated fruit juices, fruit flavors and mixtures thereof. The saccharide component can also include polysaccharides component or portion such as about 1 to 15% cornstarch. The cornstarch ingredient typically is added as part of a topical cornstarch addition to control stickiness. Some quantity of cornstarch is incorporated into the composition as a consequence of this usage of cornstarch. In preferred embodiments, the saccharde of choice is sucrose.

The improved quickly dissolving aerated confections further essentially comprise about 0.1% to 1% of a non proteinaceous whipping agent in substitution for the protein based whipping agents of U.S. Pat. No. 6,207,216. The non proteinaceous whipping agent is essential to providing the quick dissolving feature herein as well as to provide the hypoallerginicity of the present quickly dissolving convection compositions herein. Suitable non proteinaceous whipping agents are selected from the group consisting of sodium lauryl sulfate (“SLS”), sodium steroyl lactylate (“SSL”), methyl cellulose (“MC”), hydroxypropyl methyl cellulose (“HPMC”), and mixtures thereof. While not wishing to be bound by the proposed theory, it is speculated herein that these particular foaming ingredients interfere with the structuring agent in a manner such that within the ranges for whipping ingredients and structuring agents herein, compositions can be provided that exhibit the rapid or quick dissolving feature desired herein. Both SSL and SLS are well known food surfactants.

Both methyl cellulose and hydroxypropyl of various types and grades are available from the Dow Chemical Company. Generally, in the production of such substituted methyl cellulose ethers, alkali cellulose is reacted with methyl chloride alone or in combination with propylene oxide to add substitute groups. Various specific chemistry groups are labeled as “A”, “E”, “F”, and “K” groups. Also, the initial high molecular weight alkali cellulose can be subjected to controlled degradation to produce various lower molecular weight materials. Generally, as the average molecular weight is reduced, so is the viscosity at standardized concentrations. Thus, the viscosity characterization for a particular grade and chemistry material is related to its average molecular weight. Higher numbers generally indicate higher viscosity, e.g. Methocel A15 will have a higher viscosity than Methocel A3.

Also, generally as greater amounts and/or higher strength structuring agents are employed, the higher viscosity MC and HPMC materials foaming agents become less effective at providing quickly dissolving dried confections and the lower molecular weight or viscosity grades are preferred. Of course, formulating useful quickly dissolving confection compositions requires some balancing of amount and strength of the structuring agent with selection of particular types and concentrations of foaming ingredient.

Useful materials include those grades of methyl cellulose and HPMC that are those characterized by a viscosity of 3 to 450 centipoise (cps) across the various chemistries. Such useful materials specifically include, for example, those materials available under the trade designations as Methocel E3, F3, K3, E50, F50, F450, K100, and mixtures thereof. Preferred for use herein are low viscosity or lowest molecular weight varieties across the various substitution chemistries, e.g., characterized by a viscosity value of 3-50 cps and include the specific materials designated as Methocel grades E3, F3, K3, E50, F450, K100 and mixtures thereof. Most preferred for use herein for the hydroxypropyl methyl cellulose is that available under the tradename Methocel E3. Preferred for use herein is a combination of about 0.5% Methocel E3 with about 0.05% SLS especially when used in combination with gelatin as the structuring ingredient.

The skilled artisan will appreciate that these particular foaming agents are to be distinguished from other gum or thickening ingredients such as microcrystalline cellulose or carboxymethylcellulose.

The improved quickly dissolving confection essentially further includes about 0.5 to 30%, preferably about 1 to 6% and most preferably about 2.5 weight percent of a foam structuring or gelling component. Suitable structuring components include gelatin; hydrophilic colloids such as pectin; modified starches; gums such as guar and carrageenan; and, mixtures thereof. For products to be marketed in North America, the preferred structuring agent is gelatin. The gelatin can be derived from bovine, porcine, or piscine (fish) sources or can be of mixtures thereof. Due to its cost and source purity, bovine gelatin is preferred in the United States. Preferred for use herein is high Bloom strength gelatin, e.g., 200 Bloom strength or 250 Bloom strength. In another protein free embodiment, the structuring agent is a combination of carrageenan and guar gums.

The present improved aerated confectionery compositions are preferably dried to form dried frangible compositions having a reduced or residual moisture content ranging from about 1 to 6%, preferably about 1 to 3% and most preferably about 1 to 2.5%.

The confections' compositions have densities of 0.10 to 11.0 g/cc, preferably about 0.1 to 0.4 g/cc and most preferably about 0.15 to 0.3 g/cc. Preferred products have a density of about 0.1 to 0.4 g/cc at moisture contents of 1 to 6%, preferably 2 to 5%.

The food product compositions and products prepared therefrom can further comprise a wide variety of supplemental materials to improve the organoleptic, visual, or nutritional properties of the finished confectionery products. Useful materials include, for example, colors, flavors, high potency sweeteners, preservatives, nutritional fortifying ingredients and mixtures thereof. If present, such optional materials can collectively comprise from about 0.01% to about 25% by weight of the present products, preferably about 1% to 10%.

More preferably, any insoluble component such as mineral fortifying ingredient (e.g. calcium carbonate or a calcium phosphate salt for calcium fortification) is added in the form of a fine powder having a particle size such that 90% has a particle size of less than 150 micron, preferably 100 μm or less in size and for best results under 10 microns.

In highly preferred embodiments, the present products comprise a calcium ingredient of defined particle size in an amount effective to provide the desired calcium enrichment. The present food products find particular suitability for use in the inclusion of dried marbits as ingredients in child oriented Ready-to-eat cereal products. Children are in particular need of additional calcium. Good results are obtained when the present aerated confectionery compositions comprise sufficient amounts of calcium ingredients to provide the total calcium content of the composition to from about 50 to 2500 mg per 28.4 g (1 oz) serving (dry basis) (i.e., about 0.15% to 10% by weight, dry basis) of calcium, preferably about 100 to 1500 mg Ca per 28.4 g (1 oz.), and more preferably about 200 to 1500 mg calcium/oz.

Useful herein to supply the desired calcium levels are calcium ingredients that supply at least 20% calcium. Preferred for use herein are calcium ingredients selected from the group consisting of food grade calcium carbonate, ground limestone, calcium phosphate salts and mixtures thereof.

In one preferred embodiment, the improved quickly dissolving confection compositions are fat free, i.e., have fat contents of less than 5%, preferably less than 0.5% (dry weight basis). Low fat products are preferred for use herein since such products are more easily able to be formulated to form the present quickly dissolving products. In these embodiments, the fat level is provided by lipid content associated with one or more ingredients as compared to addition of a fat component. For example, when dry malted milk is used as a whipping agent, the high fat content of the malted milk (about 20%) can raise the total fat content. In other variations, e.g., chocolates, the aerated confection can comprise about 1% to 25% of an added fat component homogeneously blended with the other components preferably about 1 to 10% such as cocoa butter, dairy fat or dairy fat containing (e.g., cheese) or other edible fatty triglyceride or fat mimics such as sucrose polyesters.

The compositions can be optionally flavored and/or colored to provide uniform products or products having phases of variously colored and flavored potions. By “color” is meant a confection of any color, including white, which may be provided by the base confection ingredients, and by additional artificial or natural coloring agents. “Color” also includes various hues or shades, e.g., pink and red.

The present improved aerated confectionery compositions can be formed into products such as suitably shaped and sized pieces. In preferred embodiments, the pieces have a size count ranging from about 0.2 to 6/g, preferably about 1 to 6/g, and most preferably about 4 to 6/g. Thus, pieces can range from about 0.15 to 5 g each. As a result, these pieces generally have a bulk density of about 235 to 340 g per liter. The pieces can be in common geometrical shapes such as disks, spheres, cylinders, cubes, or shaped such as to form three-dimensional shapes. The pieces can also be in the form of wafers (e.g., having a thickness of about 1 to 30 mm preferably about 2 to 15 mm) that can have a peripheral outline of a regular shape, e.g., pentagon or animal or can be randomly shaped. In preferred form, wafers can have a cross sectional area ranging from about 15 mm² to about 900 mm². Due to their relative thinness, such wafer shaped pieces are sometimes referred to as two dimensional shapes.

In preferred embodiments, the pieces are in the form of composite pieces that additionally comprise a slowly dissolving aerated confection portion. The slowly dissolving portion is a portion that requires more than 90 seconds to dissolve in cold milk, preferably more slowly than two minutes. The slowly dissolving portion can be fabricated from known aerated confection compositions and techniques including U.S. Pat. No. 6,207,216. Generally, such compositions comprise gelatin as the whipping ingredient as well as the structuring ingredient. Also, such slowly dissolving confection compositions generally do not include the present other non-gelatin proteinaceous whipping or foaming ingredients nor the protein based whipping agents of U.S. Pat. No. 6,207,216.

The slowly dissolving portion to quickly dissolving portion can range widely from about 1:20 to about 20:1. Each portion(s) can be continuous or discontinuous. For example, one product can comprise both a core portion and also an outer shell portion. In a preferred variation, the quickly dissolving portion comprises the outermost layer or portion with the core fabricated from a slowly dissolving composition. In more preferred embodiments, the quickly dissolving external portion completely surrounds the slowly dissolving portion to form a shell. In a preferred form, the shell is in the form of an egg. Disposed within the egg or eggshell is the more slowly dissolving portion. This slowly dissolving portion can be formed into the shape of a small baby animal such as a duckling, chick, reptile, and dinosaur. Upon addition to cold milk, the egg portion quickly dissolves to reveal the contained shaped baby portion.

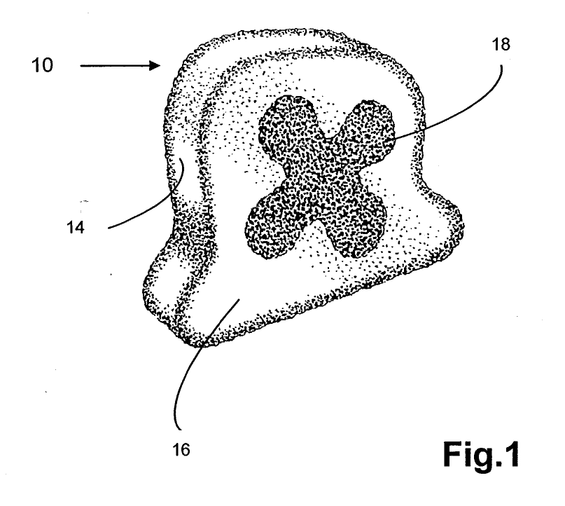

As discussed above, in another variation, the pieces can be fabricated in the form of shaped wafers, e.g., having an outline in the form of a familiar object. Referring now to the drawing, FIG. 1 depicts an aerated confection piece of the present invention generally designated by reference numeral 10. Piece 10 is in the general shape of a wafer having opposed major surfaces and includes a shaped periphery 14 such as the hat shaped outline depicted. The shape is well known and described in U.S. design 376,039 (issued Dec. 3, 1996). Piece 10 includes an outer or peripheral layer 16 that can be fabricated from a slowly dissolving aerated confection composition. However, in contrast to current products fabricated from exclusively slowly dissolving dried aerated confections and used in certain RTE cereals, piece 10 of the present invention is further seen to have a shaped second portion 18 as a core surrounded by peripheral layer 16 that can be fabricated from an improved quickly dissolving composition of the present invention. Upon addition to milk, the quickly dissolving portion “melts” away to reveal a shamrock shaped aperture. In products of the prior art, the shamrock shaped portion is the same composition of the periphery portion 16 merely of a different color but otherwise compositionally identical. In other variations, the portions 16 and 18 can be reversed so that a hat shaped wafer dissolves quickly away to form a residual shamrock shaped wafer piece. In still other variations (not shown) either portion can be discontinuous. For example, a clown shaped piece with a red eye and a blue eye and a yellow mouth can be formed each from a quickly dissolving portion that can dissolve at the same or different but fast rates. Method of preparation

In its principle method aspect, the present invention provides methods of preparing such quickly dissolving aerated confections compositions. The composition methods of preparation comprise the steps of preparing a warm slurry comprising the nutritive carbohydrate sweetening component, marshmallow structuring component a non proteinaceous foaming agent and an excess of moisture; aerating the warm slurry with nitrogen to form a hot plastic aerated marshmallow foam; forming the foam into pieces; and, drying the pieces to a dried moisture content to form quickly dissolving dried marshmallow pieces.

The hot sugar slurry preparation step can conveniently comprise the sub-steps of

admixing at least a portion of the nutritive carbohydrate component in dry form with the non proteinaceous foaming agent to form a dry blend;

admixing the dry blend in at least a major portion of water to form a sugar syrup;

admixing the balance of the nutritive carbohydrate sweetening component to the syrup;

heating the syrup to dissolve the sweeteners to about 75-100° C. (about 170-212° F.) to form a hot clear sugar syrup;

hydrating the structuring agent in the balance of the moisture to form a hydrated structuring agent;

cooling the hot clear sugar syrup to a temperature of 72° C. or cooler to form a warm clear sugar syrup;

admixing the hydrated structuring agent with the warm sugar syrup to form a warm slurry;

By these sub-steps, extended exposure of the structuring agent to elevated temperatures is minimized. Such minimization of exposure to elevated temperatures is particularly important when all or a portion of the structuring agent is supplied with a temperature sensitive ingredient such as gelatin. Also, by dry blending the foaming agents in dry form with at least a portion of the sweeteners, good dispersal of the foaming ingredients can be obtained.

The warm slurry has a slight excess of moisture ranging from about 8% to 25%, and for those compositions intended for preparation of dried marshmallow products preferably about 10 to 15%. All or a portion of the moisture can be supplied by one or more sweetener ingredients such as corn syrups or other sugar syrups.

The dry blend can additionally include the various other ingredients such as vitamins, colors and mineral or other nutritional or even pharmaceutical ingredient.

Optionally, the present methods can additionally comprise a step of adding sugar crystals to the warm slurry to form a crystal seeded warm sugar syrup. Such crystal seeding of the slurry can be practiced for better control of desired end product properties (and as more fully described in U.S. Pat. No. 6,436,455 noted above and included herein by reference).

Thereafter, the warm slurry can be aerated with added gas to desired density within the 0.1 to 1.0 g/cc range. While air or other inert gasses can be employed, preferred for use herein as the aerating gas is nitrogen. Since mechanical aeration can result in frictional heating of the foam so formed, aeration can be practiced with supplemental cooling before, during and/or immediately after the aeration step for better control of the foam temperature desirably within the range of 20 to 80° C., preferably about 50 to 60° C., to provide a warm plastic confectionery foam.

Thereafter, forming step can comprise a sub-step of extruding the aerated warm plastic confectionery foam into one or more ropes. If desired, the peripheral shape of the rope can be selected to impart a desired shape to the finished products. For those products intended as dried marshmallows, good results are obtained with rope thickness ranging from about 5-20 mm. In practice, the ropes are applied to a bed of cornstarch (with or without sugar) since the warm plastic ropes are quite sticky. Often, additional cornstarch is topically applied to the sticky top surface of the rope. The ropes are allowed to cool to below to solidify to form solid ropes. Some portion of the cornstarch is incorporated into the body of the confection, e.g., 1-15% as described above. Conveniently, the ropes are advanced along a moving belt to allow the structuring agent sufficient time to set to form ropes that can be sectioned into individual pieces without deforming the foam structure of the aerated composition. Good results are obtained when the ropes are allowed to cool for a minimum of 15-120 seconds to form the cooled solid aerated wet foams. Higher foam temperatures during extrusion can require longer cooling or setting times within this minimum range. Of course, once cooled for the minimum times to set the structure of the foam, the ropes can be allowed to cool longer or be held for extended times.

Thereafter, the cooled structure set ropes can then be cut or sectioned into individual pieces by suitable cutting means such as by employing a reciprocating guillotine knife or other slicer. In a preferred variation, a high speed rotary knife is employed such as is described in U.S. Pat. No. 6,251,203 “Method and Apparatus for Processing Aerated Confectionery Foam Rope” (issued Mar. 6, 2001 to Zietlow et al. and incorporated herein by reference). Preferred herein is to form thin wafers ranging from about 1 to 10, preferably about 2-5 mm in thickness although thicker products for soft marshmallow products are also contemplated.

Conveniently, the pieces so formed are put through a scalper to remove cornstach from the pieces to provide destarched peices. The cornstarch can be captured and recirculated.

In the manufacture of soft marshmallow or other soft confections, the products so prepared are finished are ready for conventional packaging for distribution and sale. Such products can have a moisture content ranging from about 20-25%.

However, in the preparation of a dried aerated confection such as the marbit, the present methods additionally comprise a finish drying step and each of the individual and destarched pieces can be dried. Any suitable drying technique which will remove the moisture content to be about 2-4% is adequate. A suitable method is taught in U.S. Pat. No. 4,785,551 entitled “Method of Drying Confection Pieces” which is incorporated herein by reference. The '551 patent teaches a rapid, five minute drying step using a two-step fluidized bed heating step. In another preferred technique, the marbits are dried at a slower rate using forced hot air convection drying. For example, the pieces can be put on trays, mounted in a frame that holds about 30-40 trays, and rolled into a drying room until adequately dried. The drying room is kept at a temperature of about 82.2° C. (180° F.). In other implementations, the pieces are transported by a conveyor through a drying room or tunnel until the desired moisture content is reached.

The resulting dried pieces can then be consumed as confections or added to conventional RTE cereals. An advantage is that such confectionery products rapidly dissolve in the cold milk with which such RTE cereals are conventionally consumed. An additional advantage, particularly for those products fabricated from gelatin free compositions is that the products are protein free and thus hypoallergenic to those consumers sensitive to various milk or soy protein ingredients. Also, such products are generally wheat ingredient free as well and thus are suitable for use in wheat free cereal products to provide hypoallergenic products to those sensitive to wheat ingredient food allergies. Also, in preferred form, the confections are desirably free of any nut ingredient especially peanut ingredients to provide hypoallergenic foamed confection products.

In another method aspect, the present invention further provides methods for preparing composite products comprising a first portion having at least one colored portion fabricated from a quickly dissolving aerated confection composition of the present invention and a second portion comprising a slowly dissolving aerated confection composition.

The present methods essentially involve the combining without intermixing of a first stream, portion or supply of a quickly dissolving aerated confection with a second stream, portion or supply of a slowly dissolving aerated confection and co-extruding the two streams to form combined extrudate having at least two phases at least one of which is each slowly and quickly dissolving.

More specifically, the present methods comprise a first step of providing a first steam of first aerated confection composition having one portion fabricated from a quickly dissolving aerated confection composition in the form of a plastic mass having: a moisture content of about 8% to about 25%; a density of about 0.1 to about 1.0 g/cc; and a temperature of about 2082° C. (70 to 180° F.). The present methods further comprise a second step of providing a second steam of a second aerated confection composition fabricated from a slowly dissolving aerated confection composition having moisture content of about 8% to about 25%; density of about 0.1 to about 1.0 g/cc temperature of about 2082° C. (70 to 180° F.). The present methods further comprise a second step of co-extruding the first steam and second steam under pressure in an extruder without substantial intermingling of the extrusion steam to form a combined steam. Thereafter, the present methods further comprise the steps of severing the combined steam into pieces; and drying the moist composite aerated confection pieces to a moisture content of about 1% to 8%, preferably about 1% to 6%, to form dried aerated confections having a first quickly dissolving portion and that dissolve in second slowly dissolving portion. The moist pieces prior to drying will typically have moisture contents of about 8% to about 25%. The dried pieces have a density of about 0.1 to about 0.4 g/cc and in preferred embodiments each weigh about 0.1 to 7 grams. The dried pieces dissolve in water or in a dairy beverage having a temperature above freezing to about 65° C. in less than 120 seconds.

The composition ingredients can be combined and processed to form aerated warm, plastic confectionery foams using conventional equipment and techniques. The foams can be shaped into pieces such as by extruding the foam and allowing the foam to set, forming the set foam into pieces such as by severing starch covered set foam to form the moist pieces. In preferred embodiments, a quickly dissolving aerated confectionery composition is co-extruded with a slowly dissolving aerated confection composition to form composite pieces. Such techniques are especially useful to prepare “two dimensional” pieces such as wafers. Other piece shaping techniques can also be employed such as starch molding. These techniques are especially useful to prepare “three dimensional” pieces such as eggs.

The present methods further comprise an essential step of drying the aerated confection pieces to a moisture content of about 1% to 6% to form dried aerated confections that at least a portion thereof dissolve in cold skim milk in less than 90 seconds. The finished dried pieces can weigh 0.1 to about 5 g.

The resulting tempered dried aerated confectionery pieces can then be consumed as confections.

The dried aerated confectionery pieces, particularly dried marshmallow pieces, find particular suitability for use as an appealing added component of food products to provide novelty or play value. For example, the pieces may be admixed with a Ready-To-Eat (“R-T-E”) breakfast cereal, especially sugar coated R-T-E cereals, intended as children's breakfast cereals.

In a preferred embodiment, the finished RTE cereal can comprise about 60 to 99% of a conventional dried cereal (such as biscuits flakes, puffs, shreds, and mixtures thereof, formed from a cooked cereal grain or dough of oats, wheat, corn, barley, rice or mixtures) and about 1% to about 40% by weight of the present novel dried marshmallow pieces. In still other variations, the present confections can be admixed with instant oatmeal, dry cocoa beverage mix (especially smaller sized pieces), and dry mixes for other products. The confections can also be used in cereal bar products, toppings for desserts such as ice cream or yogurt, or on various baked goods.

In other variations, the confections provide appealing carriers for various pharmaceuticals whether containing over-the-counter medications or ethical or proscribed drugs or, vitamins, minerals, nutraceuticals, dietary supplements and the like. Due to the aerated and frangible texture, the confections are easy to chew and are quickly dissolving.

### EXAMPLE 1

A quickly dissolving aerated food product of the present invention is prepared having a base fabricated from a composition having the following formulation:

| Ingredient | Weight % |
|---|---|
| Sucrose | 83 |
| hydroxy propyl methyl cellulose | 0.5 |
| (Dow Chemical Co - Methocel E3) | |
| Sodium lauryl sulfate | 0.05 |
| Guar gum | 2.0 |
| Carrageenan | 0.3 |
| Moisture | balance |
| | 100.0% |

The above formulation is formed into an aerated foam having a density of about 0.27 g/cc. Shaped pieces are prepared from this composition having about four to six pieces per gram. The shape pieces are dried at below 21° C. (70<° F.) to a final moisture content of about 5% to form quickly dissolving pieces.

Products substantially equivalent are prepared when in the above example 1 the guar gum and carrageenan gum are substituted with an equivalent amount of gelatin.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An aerated food product in the form of pieces comprising:
a first quickly dissolving portion that dissolves in (i.e., 5° C.) water or a dairy beverage in about 10 to 120 seconds, fabricated from a quickly dissolving composition comprising
about 65% to 98% of a saccharide component (dry weight basis);
about 0.5 to 30% of a structuring agent; and,
about 0.5% to 1% of a non-protein whipping agent
said first quickly dissolving portion having:
at least one color,
a density of about 0.1 to 1 g/cc, and,
a moisture content of about 1% to 2.5%,
said pieces each weighing from about 0.1 to 15 g.

2. The aerated food product of claim 1 wherein the first quickly dissolving portion is substantially free of a protein whipping agent.

3. The quickly dissolving aerated food product of claim 1 wherein the whipping agent is selected from the group consisting of sodium lauryl sulfate, methyl cellulose, hydroxypropyl methyl cellulose, sodium stearoyl lactylate, and mixtures thereof.

4. The quickly dissolving aerated food product of claim 3 wherein at least a portion of the structuring agent is gelatin.

5. The quickly dissolving aerated food product of claim 3 wherein the structuring agent is selected from the group consisting of carrageenan gum, guar gum and mixtures thereof and wherein the quickly dissolving composition is free of gelatin.

6. The quickly dissolving aerated food product of claim 4 wherein the density ranges from about 0.15 to 0.3 g/cc.

7. The quickly dissolving aerated food product of claim 6 comprising:
about 65 to 98% of a saccharide component; comprising about 1 to 8% moisture and wherein at least a major portion of the saccharide component is sucrose
about 0.5 to 10% of a structuring agent; and,
about 2 to 5% moisture; and,
about 0.1% to 1% of a protein whipping agent.

8. The quickly dissolving aerated food product of claim 7 wherein at least a portion of the non-protein whipping agent is comprises methyl cellulose, hydroxy propyl methyl cellulose, and mixtures thereof.

9. The quickly dissolving aerated food product of claim 4 having a fat content of less than 5%.

10. The aerated food product of claim 1 in the form of shaped pieces at least a first portion of which comprises the quickly dissolving aerated food product.

11. The aerated food product of claim 10 having a piece count of about 2 to 6 per gram.

12. The food product of claim 1 that dissolves in whole milk having a temperature of 2 to 10° C. in about 20 to 90 seconds.

13. The food product of claim 1 having a moisture content of about 1% to 2.5%.

14. The food product of claim 8 wherein at least a portion of the whipping agent is a sodium lauryl sulfate and at least a portion of the structuring agent is gelatin.

15. The food product of claim 10 additionally comprising a second portion of a slowly dissolving aerated confection.

16. The food product of claim 15 wherein the weight ratio of quickly dissolving aerated food product portion to second portion of a slowly dissolving aerated confection ranges from about 20:1 to about 1:20.

17. The food product of claim 16 wherein the slowly dissolving portion is substantially free of a soy protein hydrolyzate.

18. The food product of claim 17 wherein the slowly dissolving portion is fabricated from an aerated confection composition such that a 0.2 g piece requires at least two minutes to dissolve in cold milk.

19. The food product of claim 18 wherein the slowly dissolving portion is of a second color.

20. The food product of claim 15 wherein the quickly dissolving aerated food product portion is in the form of a topical coating.

21. The food product of claim 20 wherein the quickly dissolving aerated food product portion is in the form of a topical coating completely surrounding the second portion of the slowly dissolving aerated confection.

22. The food product of claim 21 wherein the coating is in the form of an rounded shape.

23. The food product of claim 22 wherein the second portion of a slowly dissolving aerated confection is in the form of an animal.

24. The food product of claim 23 wherein the second portion of a slowly dissolving aerated confection is of a different color than the topical coating.

25. The food product of claim 20 wherein the second portion has at least two phases characterized by different colors, flavors or composition.

26. The food product of claim 16 in the form of a wafer.

27. The food product in the form of a wafer having a thickness of about 1 to 5 mm.

28. The food product of claim 26 wherein the quickly dissolving aerated food product portion is in the form of a peripheral border.

29. The food product of claim 26 wherein the slowly dissolving aerated food product portion is in the form of a peripheral border.

30. The food product of claim 26 wherein the quickly dissolving aerated food product portion is in the form of core.

31. The food product of claim 30 wherein the portions are of differing colors.

32. The food product of claim 31 admixed with a ready-to-eat breakfast cereal.

33. The food product of claim 8 additionally comprising sodium lauryl sulfate.

34. The food product of claim 33 wherein the structuring agent is gelatin.

35. The food product of claim 34 having a density of about 0.15 to 0.3 g/cc.

36. The food product of claim 35 having a piece count of about 2 to 6 per gram.

37. The food product of claim 34 wherein the gelatin is 250 Bloom strength.

38. The food product of claim 1 having a moisture content of 2.0-2.5%.

39. The food product of claim 34 additionally calcium fortified.

40. A method for preparing a composite aerated confectionery food product, comprising the steps of:
A. providing a first steam of first aerated confection composition having one portion fabricated from a quickly dissolving aerated confection composition having:
a moisture content of about 8% to about 25%;
a density of about 0.1 to about 1.0 g/cc;
a temperature of about 70 to 180° F.; and,
B. providing a second steam of a second aerated confection composition fabricated from a slowly dissolving aerated confection composition having:
a moisture content of about 8% to about 25%;
a density of about 0.1 to about 1.0 g/cc;
a temperature of about 70 to 180° F.; and
C. co-extruding the first steam and second steam under pressure in an extruder without substantial intermingling of the extrusion steam to form a combined steam;
D. severing the combined steam into pieces; and
E. drying the aerated confection pieces to a moisture content of about 1% to 6% to form dried aerated confections having a first quickly dissolving portion and a second slowly dissolving portion.

41. The method of claim 40 wherein the first quickly dissolving composition comprises:
about 65% to 98% of a saccharide component;
about 0.5 to 30% of a structuring agent; and,
about 0.1% to 1% of a protein whipping agent.

42. The method of claim 41 wherein the protein whipping agent is a soy protein hydrolyzate.

43. The method of claim 42 wherein the quickly dissolving composition has a fat content of less than 5%.

44. The method of claim 43 wherein the quickly dissolving composition has a fat content of less than 0.5%.

45. The method of claim 44 wherein the weight ratio of first quickly dissolving aerated food product composition to second slowly dissolving aerated confection composition ranges from about 20:1 to about 1:20.

46. The method of claim 45 wherein the slowly dissolving composition is substantially free of a whipping protein.

47. The method of claim 46 wherein the slowly dissolving composition is fabricated from an aerated confection composition that a 0.2 g piece requires at least two minutes to dissolve in cold milk.

48. The method of claim 47 wherein at least a portion of the slowly dissolving composition is of a second color.

49. The method of claim 48 wherein the quickly dissolving aerated food product composition is in the form of a topical coating.

50. The method of claim 49 wherein the quickly dissolving aerated food product composition is in the form of a topical coating completely surrounding the second slowly dissolving aerated confection composition.

51. The method of claim 50 wherein the coating is in the form of an eggshell.

52. The method of claim 50 wherein the second slowly dissolving aerated confection composition is in the form of an animal disposed within the eggshell.

53. The method of claim 52 wherein the second slowly dissolving aerated confection composition is of a different color than the topical coating.

54. The method of claim 46 wherein the second slowly dissolving aerated confection composition has at least two phases characterized by different colors, flavors or composition.

55. The method of claim 50 in the form of a wafer.

56. The method of claim 55 in the form of a wafer having a thickness of about 1 to 5 mm.

57. The method of claim 55 wherein the quickly dissolving aerated food product composition is in the form of a peripheral border.

58. The method of claim 56 wherein the slowly dissolving aerated food product composition is in the form of a peripheral border.

59. The method of claim 53 wherein the quickly dissolving aerated food product composition is in the form of core.

60. The method of claim 52 wherein the compositions are of differing colors.

61. The method of claim 60 additionally comprising the step of: admixing the pieces with a ready-to-eat breakfast cereal.

62. The product prepared by the method of claim 40.

63. The product prepared by the method of claim 41.

64. The product prepared by the method of claim 45.

65. The product prepared by the method of claim 47.

66. The product prepared by the method of claim 51.

67. A method for preparing a preparing a quickly dissolving aerated confection, comprising the steps of:
A. preparing a slurry comprising:
about 80% to 85% nutritive carbohydrate sweetening component,
about 2%-15% of a confection structuring component,
about 0.1% to about 1% of a non proteinaceous foaming agent, and
the balance of moisture
B. Aerating the slurry to form a plastic aerated confection foam having a moisture content of about 10% to about 15% and a temperature of about 20 to 80° C.;
C. Forming the foam into pieces; and,
D. Drying the pieces to a moisture content of 1-2.5% to form quickly dissolving dried marshmallow pieces.

68. The method of claim 67 wherein the slurry preparation step A comprises the sub-steps of:
comprising the substeps of:
admixing at least a portion of the nutritive carbohydrate component in dry form with the non proteinaceous foaming agent to form a dry blend;
admixing the dry blend in at least a major portion of water to form a syrup;
admixing the balance of the nutritive carbohydrate sweetening component to the syrup;
heating the syrup to dissolve the sweeteners to about 75-100° C. (about 170-212° F.) to form a hot clear sugar syrup;
hydrating the structuring agent in the balance of the moisture to form a hydrated structuring agent;
cooling the hot clear sugar syrup to a temperature of 72° C. or cooler to form a cooled clear sugar syrup; and
admixing the hydrated structuring agent with the cooled sugar syrup to form a slurry;

69. The method of claim 68 wherein the non proteinaceous agent is selected from the group consisting of sodium lauryl sulfate, hydroxypropyl methyl cellulose, sodium stearoyl lactylate, and mixtures thereof.

70. The method of claim 69 wherein the structuring agent is selected from the group consisting of carrageenan gum, guar gum and mixtures thereof and wherein the quickly dissolving composition is free of gelatin.

71. The method of claim 69 wherein at least a portion of the structuring agent is gelatin.

72. The method of claim 69 wherein the aeration step is practiced to provide a foam having the density ranging from about 0.15 to 0.3 g/cc.

73. The method of claim 69 wherein at least a portion of the foaming agent is hydroxy propyl methyl cellulose.

74. The method of claim 73 wherein the dried pieces have a piece count of about 2-6/g.

75. The method of claim 74 wherein at least a portion of the foaming agent is sodium lauryl sulfate.

76. The method of claim 71 wherein the gelatin is high bloom strength gelatin.
